(19) United States
(12) Patent Application Publication
(10) Pub. No.: US 2026/0277914 A1
(43) Pub. Date: Sep. 17, 2026

(54) A method to provide comprehensive key vocabulary for search

(71) Applicant: M/S. BDSR SOLUTIONS LLP, Bangalore (IN)

(72) Inventors: Kothapalli Raghava Rau, Bangalore (IN); Swarna Latha, Bangalore (IN)

(21) Appl. No.: 18/868,420

(22) PCT Filed: May 24, 2024
(86) PCT No.: PCT/IN2024/050608

§ 371 Date: Nov. 22, 2024

(30) Foreign Application Priority Data
Aug. 1, 2023 (IN) 202341051765

(51) Int. Cl. G06F 16/2457; G06F 16/215; G06F 16/248

(52) U.S. Cl. CPC G06F 16/24578; G06F 16/215; G06F 16/248

(57) ABSTRACT

The present invention relates to a method to provide comprehensive key vocabulary for search involving the steps of receiving (101) a user-specified term or phrases with text cleaning (101A), identifying (102) domain specific vocabulary, extracting (103) relationship between plurality of key phrases in a text document, deriving (104) a knowledge graph that involves in establishing relationship between two phrases and a connection to form edge relationship thereby deriving a lemma, improving (105) the quality of the key phrases, storing (106) phrases, document ids and statistical details about phrases, ordering (107) the phrases identified using the ranking criteria based on the phrases statistics, selecting (108) and returning the best key phrases as search results and showing (109) the search results as word cloud for the users to quickly identify the key vocabulary.

### FIELD OF THE INVENTION

The present disclosure is related to a method to provide comprehensive key vocabulary in the relevant area where a researcher is searching in internet. Also, the present invention relates to provide high quality key vocabulary or phrases that can be used to search for highly relevant results.

### BACKGROUND OF THE INVENTION

Usually, search on internet involves the entry of relevant keywords to obtain the relevant results. The search can be many categories such as searching for deals for items shopping, students searching course topics, searching news or videos for information or entertainment, researchers searching for relevant research papers and other such searching activities. The search involves search query (one or more words) in generic search engines like Google, Microsoft Bing, Yahoo, etc. to perform the search. Also, specialized search portals such as Job portals such as Naukri.com, Monster.com etc. and e-Commerce platforms such as Amazon, Flipkart etc. can also be used for specific searches.

In order to avoid these problem, a published prior art CN115017344A titled ‘Keyword recommendation method, device, equipment and storage medium’ discloses the technical field of search, and discloses a keyword recommendation method, a keyword recommendation device, keyword recommendation equipment and a storage medium, wherein the method comprises the steps of extracting a search keyword from a search instruction when the search instruction input by a user is received; when the search keyword does not meet the preset condition, acquiring a multimedia information keyword candidate set corresponding to a user; determining a user interest word set according to a preset fine-grained identification strategy and a multimedia information keyword candidate set; recalling the multimedia information keyword candidate set and the user interest word set respectively according to a preset recalling strategy to obtain a plurality of keyword updating candidate sets; and carrying out rough sorting on the keyword updating candidate set, and recommending the keywords according to a sorting result. In the invention, when the search word input by the user does not meet the preset condition, namely the search word is not standardized or semantic confusion cannot be identified, the multimedia information keyword is recommended by fusing the user behavior of comprehensive search, namely the candidate set of the multimedia information keyword corresponding to the user.

In another prior art U.S. Pat. No. 10,540,347B2 titled “Contextual search disambiguation” discloses methods, systems, computer-readable media, and apparatuses for providing search disambiguation using contextual information and domain ontologies are presented. In some embodiments, a computing device may receive a natural language input from a user. The computing device may identify a plurality of hypotheses for the natural language input. The computing device may map the plurality of hypotheses to one or more concepts of a plurality of concepts of an ontology by annotating the one or more concepts. The ontology may include the plurality of concepts respectively connected by a plurality of relations. The computing device may determine that there is an imperfect match between the annotated one or more concepts and annotations of answers. In response, the computing device may disambiguate the annotated one or more concepts using the ontology. The computing device may present output to the user based on the disambiguation.

In another prior art application numbered US20120239643A1 titled “Context-aware search” discloses an embodiment of the present invention sets forth a technique for supplementing user-specified text for a search with context information to generate search results that is more closely matched to the user's needs. A context search component maintains a snapshot of the user context and additional context-based queries are generated and corresponding searches are performed. The search results of the context-based queries are merged with the results of the user-specified text query and displayed for the user. When the user accesses a resource listed in the merged search results, the context-based terms mentioned in the resource are identified to the user.

In another prior art application numbered U.S. Pat. No. 9,015,176B2 titled “Automatic identification of related search keywords” discloses a keyword expansion is used to expand a particular keyword into multiple related keyword candidates using a collection of data that relates to search queries performed using one or more search engines. The data identifies search terms from associated search queries. A particular keyword is identified and one or more candidate keywords related to the particular keyword are identified based on the data.

In another prior art publication titled “Domain Specific Custom Search for Quicker Information Retrieval” authored by Tushar Kanti Saha & Shawkat Ali describes the proposal of combined custom search with domain-specific search and named as domain specific custom search in this research. The research document introduces a domain specific custom search technique using new search methodology called n-paged-m-items partial crawling algorithm. This algorithm is a real-time faster crawling algorithm due to the partial crawling technique. It does not store anything in the database, which can be shown later on to the user. The proposed algorithm is implemented on a new domain scholar.google.com to find out the scholars or experts quickly.

Existing search solutions are not effective and most of the times almost similar results are obtained. Researchers use iterative approaches to improve search terms relevant for their research needs. Recently sophisticated tools such as ChatGTP (from OpenAI) or Bard (from Google.com) have arrived in the market. These solutions are based on Large Language Models which are based on 100's of billions of parameters in the complex Deep Neural Networks model. These LLM models are trained with millions of documents available in Wikipedia and other public repositories. These new solutions give conversational ability in human language to users. These solutions are better than the earlier search engines in terms of giving summarized answers for the questions that are posed based on the knowledge derived in training. The existing solutions are still considered ineffective for the researchers as it depends on the questions posed. Asking right questions is still a challenge and can be time consuming. Ideally a search engine that gives all the relevant vocabulary in their research area will be highly beneficial to researchers. Such knowledge search engine will enable them to learn the state-of-art of research quickly and they developing solutions faster to important real-world business problems. The present invention provides all the right key vocabulary relevant for the researchers' or user area of interest and search accordingly. The present invention is a developed fully working prototype Researcher Knowledge Search Engine that helps researchers to search in deep learning area.

### Objectives of the Invention

Accordingly, the primary objective of the present invention is to provide a method for comprehensive key vocabulary in relevant area for searching.
1. It is another objective of the present invention to provide a comprehensive list of relevant semantic key words for a search query.
2. It is also another objective of the present invention to extract key phrases from documents where the user search query results are ranked with highly relevant key phrases.
3. It is yet another objective of the present invention to combine similar key phrases using deep learning approaches.

### SUMMARY OF THE INVENTION

The present invention relates to implement a method (100) for generating key vocabulary phrases.

An aspect of the present invention is to implement a method of receiving (101) a user-specified term or phrases, identifying (102) domain specific vocabulary, extracting (103) relationship between plurality of key phrases, deriving (104) a knowledge graph.

An aspect of the present invention is to implement a method of receiving (101) a user-specified term or phrases by means of typing text or voice input which denotes the mode of input through input devices such as keyboard, touchscreen, microphone and other such devices to the method (100) for generating vocabulary phases.

Another aspect of the present invention is to implement a method of text cleaning of user-specified term or phrases (101A).

Another aspect of the present invention is to implement a method of storing (106) phrases, document ids and statistical details about phrases such as frequency, Term Frequency-Inverse Document Frequency (TF-IDF) in a knowledge graph database.

Another aspect of the present invention is to implement a method of ordering (107) the phrases identified using the ranking criteria based on the phrases statistics.

It is also another aspect of the present invention is to select (108) and return best key phrases as search results.

It is yet another aspect of the present invention is to show (109) the search results as word cloud for the users to quickly identify the key vocabulary.

### BRIEF DESCRIPTION OF DRAWINGS

For a more complete understanding of the present invention, reference is now made to the following descriptions taken in conjunction with the accompanying drawing, in which:

FIG. 1: Illustrates the computer-implemented method for generating key vocabulary phrases, the method comprising the steps of.

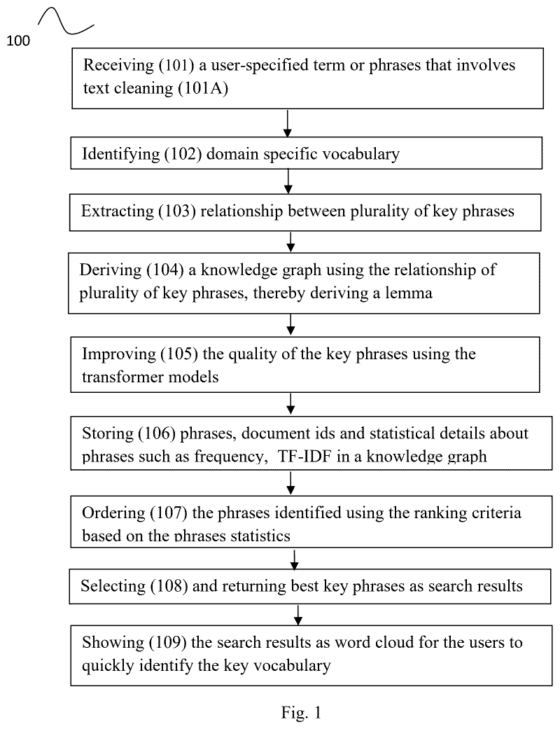

FIG. 2: Illustrates the flow chart of deriving a knowledge graph.

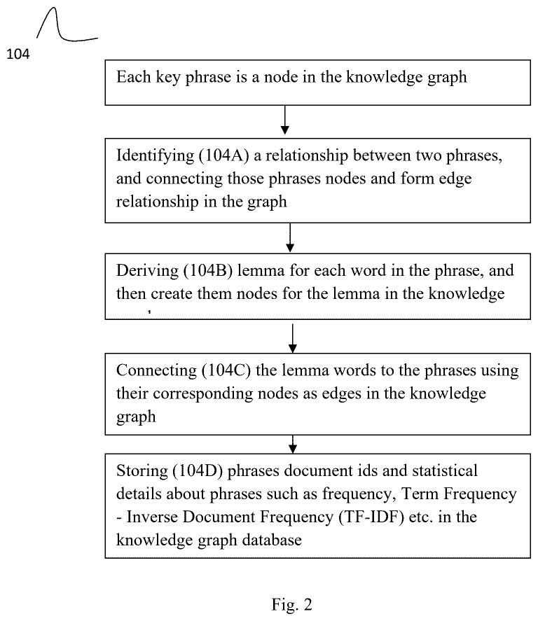

### DESCRIPTION OF THE INVENTION

Usually searching the Internet can be done for many categories such as:
1. Searching for deals for items shopping,
2. Students searching course topics
3. Searching news or videos for information or Entertainment
4. Researchers searching for relevant research papers

The users use search query (one or more words) in generic search engines like Google, Microsoft Bing, Yahoo, etc. to perform the search. Also specialized search portals such as Job portals such as Naukri.com, Monster.com, etc. and e-Commerce platforms such as Amazon, Flipkart, etc. are used for obtaining specific results.

### Problems with Search Results

Relevant search results are returned based on keywords used in the search query. Always search results are not relevant. The quality of search results depends on the words that are used in the search query. Search results have many of the following problems:
1. Generic words may result in large number of irrelevant results.
2. Specific words may give relevant results or may not yield any results.
3. Changing a few the words may not yield very different results.
4. There may be many common results between slight variations of words in two search queries.
5. Choosing right set of words may be very difficult and increase the cost of search.
6. Even though the search engine may indicate huge numbers like millions or billions of search results it will not let a user to view more than 200 results.
7. Furthermore, many results are very similar to each other.
8. The content in different web pages is almost semantically similar.
9. Actual quality results may be between 5 to 20. Searching for these small number of quality results is cumbersome for users
10. Sometimes the results can come from multiple domains which a user may not be interested in. For example, a school student searching for a biology related content may get irrelevant search results that are at college level.
11. Many a times search results are based on popularity as one of the criteria based on which we get search results at introductory level when generic words are used in the search query.

### Need for Relevant Results

The word researchers here are used in broad terms. Researchers can mean any of the following:
1) Scientists involved in research activities
2) Students who are exploring the quest for knowledge on the internet,
3) Software developers who are interested in developing new technologies
4) Tech support engineers
5) Innovators interested in developing new solutions to real life business problems etc.

Researchers search to get results quality results that can help to:
1) Expand knowledge.
2) Utilize the existing knowledge as much as possible to quickly develop solutions to research problems.
3) Avoid rediscovering existing knowledge through expensive and time taking research work.
4) Improving chances of success in developing right solutions.
5) Reducing the risks of failed outcomes that are in inherent in research efforts.
6) Help to become experts in a knowledge area.

As there is a transform from industrial society to knowledge-based society, the importance of quality search results has become very important.

Search engine such as google scholar returns results from published papers in journals or conferences only instead results from all sundry websites that contains details related to the search query. These results are mostly useful for academicians involved in research. Google scholar may not be very useful for the broad set of researchers defined in earlier section. Even for academic researchers also, the results may not be satisfactory as results are highly dependent on search query. To get good quality results, researchers may have to go through many papers spending many weeks to improve the search queries to get better results that are relevant.

### An Example of Current Results Quality

For example, when searching for “time series” in Google, it shows that there are huge numbers (about 8.28 billion) of results. Even though such huge number is shown, a user can see around 200 results at max scrolling through the search pages.

Further a vast majority of results are based on following areas:
1. Time series definition
2. Time series analysis
3. Time series forecasting
4. Time series examples
5. Guide to time series

As seen about all the results are very generic, introductory or beginner level areas. These results are not very useful for the researcher to pursue in terms of expanding knowledge at a faster pace. Discovering new vocabulary in the domain is still a challenging, cumbersome and a time-consuming task. One must manually go through each of search result, spend time to identify useful vocabulary.

The present invention for Researchers' Search for Knowledge. The present invention is to provide comprehensive key vocabulary in the area a researcher is searching. The key vocabulary can in turn be used to search for highly relevant results.

For example, if the keyword “time series” is used in the search query and in return get the following key vocabulary then the researchers can enhance knowledge very much.

| Univariate Time | Multivariate Time | Time Series |
|---|---|---|
| Series | Series | Forecasting |
| Components of time | Time Series Analysis | Time Series |
| Series | | Classification |
| Time Series Clustering | Time Series Anomaly | High Dimensional |
| | Detection | Time Series |
| Bayesian Time Series | Financial Time Series | Probabilistic Time |
| | | Series Forecasting |
| Stochastic Time Series | Nonlinear Time Series | Medical Time Series |

The above kind of vocabulary is very helpful to not only gain good knowledge in the domain but also help the researcher in coming up with the accelerated development of solutions to complex real-life problems. Meaningful extraction of Phrases from documents is an important aspect in the Researchers Knowledge Search Solution. Phrases Extraction also called as Key Phrase Extraction or Key Words Extraction is a well-studied area in the Natural Language Processing.

The present invention implements using proprietary deep learning algorithms. For example, searching for “Neural Networks” in the present invention gives highly rich word cloud of neural networks related vocabulary. The vocabulary is very useful for the researcher to gain knowledge about area of research in the fastest way possible compared to traditional search approaches.

Searching on specific topic will give relevant web pages where one can learn the details. For example, the search on topic “SIGN Structure-ware interactive graph neural network”, would give relevant results as links.

The objective of the knowledge search engine of this present invention is to enable researchers to develop quickly deep learning solutions to a variety of real-world problems in agriculture, climate change, etc. For example, an AI based solutions for farming can benefit an insurer to understand potential crop damages based on crop growth patterns from satellite images.

### Implementation Approach of Deep Learning Search Engine

1. Gathering publicly available research papers from the reputed sources such as ACM, IEEE, Scholar.google.com, NeuroIPS, arxiv.org, etc.
2. The documents can come in many formats such as HTML pages, PDF documents, scanned images, Word documents, etc.
3. Extracting text from the documents using approaches such as image to text, HTML parsing, PDF parsing, etc.
4. Preprocessing of text from documents to eliminate different types of noise in the text.
5. Some types of noise in the text are:
   a. HTML links to sources such as datasets, source code of algorithms, reference links, video lectures etc.
   b. Text that may not be relevant to the topic of the paper. For example, information about the sponsors, institute etc.
   c. Mathematical equations, figures, pictures, flowcharts, tables etc. Even though these contain details highly relevant to the paper under consideration, extracting information such things are challenging and not considered as part of this work.
   d. Non-English text in the papers. The present invention focused on research papers in English language even though other language papers may have wealth of information useful to researchers.
6. Remove the above kinds of noise from the documents using various parsing libraries available for HTML, PDF, text, etc. by using the logic relevant for the type and sources of documents.
7. Similarly use language detection libraries/Google to detect the language of a paper. If a paper is in non-English language, then don't consider the paper.
8. Once noise is removed from the documents, again use the libraries to extract the text along with relevant meta data details such as title, section names, subsection names, paragraphs, literature references etc.
9. Text Cleaning of document. There can be errors in parsing or extracting the text from documents and the resulting text can contain many types of errors some of which are listed below:
   a. Wrong hyphenation of words. Sometimes a word-processors can break words at the end of the line by creating a hyphen within a word where the break is introduced. In such case a part of the word is at the end of the line and remaining part of the word is in next line or next page.
   b. Some compound words are hyphenated in some papers and not hyphenated in other papers. Normalize such compound words so that the hyphen differences won't cause challenges in subsequent text mining steps.
   c. Fusing of two or more words make an incorrect language word.
      i. For example, “in the” can be fused as “inthe” word due to errors in parsing and extraction.
   d. Identifying domain specific vocabulary. These words are used the context of a specific domain but are not part of standard English language. Identifying such words and adding to the vocabulary is an important step in the entire solution approach.
   e. Correcting Spelling mistakes. There are common problems in draft versions of a research paper that is available. The solution steps are:
      i. If a given word is not part of wither standard English vocabulary of the domain specific vocabulary, then most likely the word is a spelling mistake.
      ii. We use sub-word tokenization methods such as Byte-pair encoding (BPE), WordPiece or SentencePiece approaches, we derive sub word tokens of a given word.
      iii. Using the context of other words and sub word tokens of misspelled word are used to identify correct word using transformer approaches.
      iv. The approach repairs the misspelled words and create correct word tokens.
      v. The approach also corrects any missing spaces due to fused words or spurious spaces in the text.
      vi. For example, the misspelled text “tokeniztonrep air” will be corrected to “tokenization repair”.
10. Abbreviations Extraction: Research papers contain may abbreviations along with g definitions. For example, in the sentence, “Convolutional Neural Networks (CNN) can be used to recognize Faces in images”. In the sentence, CNN is the abbreviation and Convolutional Neural Networks is the definition of the abbreviation. We used ruled based extraction method and in particular Schwartz-Hearst method is used to extract abbreviations along with definitions from the papers.
11. Detecting an abbreviation in a paper when the abbreviation definition is not available and replacing the abbreviation with right definition. An abbreviation may have multiple definitions across multiple papers. Once the abbreviation is detected, replace the abbreviation with the correct definition based on the context words around the abbreviation using transformer models.
12. Tokenization of sentences from text document. By using BERT based Sentence Tokenization approach to tokenize sentences. Also use the NLP libraries available for this task.
13. Parts-of-speech Tagging of word tokens. Use of fine-grained parts-of-speech approach available in standard NLP libraries. These libraries handle the homonyms to have same spelling or found but different parts-of-speech.
14. Dependency parsing of words in a sentence gives the dependency relationship of a word with other words in a sentence.
15. Extracting noun phrases and verb phrases from sentences using the rules-based approach.
16. Many noun phrases and verb phrases extracted using the rules-based approach contain the following problems.
   a. Those phrases may not be relevant in the context of the domain that are interested in. For example, phrases such as “a huge dataset” or “best results” or “state-of-the-art algorithms” that are generally used in deep learning research papers won't give any vocabulary highly relevant for the domain. Eliminate such key phrases using transformer-based models.
   b. Some words in the relevant key phrases are too generic and won't add value to the phrase. Removing such words from the phrase improves the quality of the phrase in the domain context. For example, “COCO dataset” is a more useful phrase than the “a huge COCO dataset” phrase. Here the word “huge” is not giving any additional information and removing the word makes the phrase better.
   c. A word may be useful in one context and not useful in some other context. For example, a word “English” may be not be relevant in “English text” phrase but useful in “English corpus” phrase.
17. Improving the quality of the key phrases (105) by addressing the above problems using the transformer models. Here are brief details of the transformer model used for improving the phrases quality.
   a. Categorize each word in the phrase as useful or not useful.
   b. Use phrase words, dependency words (based on dependency parser), parts-of-speech tags for the words (phrase as well as dependency words as input to the model.
   c. Using transformer model Bidirectional Encoder Representations from Transformers (BERT or BERT variants) to train the above model.
   d. As there can be millions of phrases in a domain (for example in Deep Learning area), use incremental training approach to train the model. Incremental training approach is discussed later.
   e. Once the model reaches 90+% accuracy level, use the model to predict usefulness of words the phrase and accordingly drop the phrase if majority useful or drop the not so useful words and derive quality phrases.
18. Key Phrases similarity—The phrases extracted contains many similar phrases. For example, key phrases such as “Convolutional Neural Network”, “convolutional neural networks” are similar and “convolutional neural networks” can be used in place of all other phrases. To achieve this, the following steps are used:
   a. Rules based approach to derive popular word for a given word in the phrase considering the word lemma (derived from lemmatization approach) and replace each word in the phrase with popular word
   b. Text similarity using Jaccard distance approach and merge two phrases if the distance between them is less than the threshold
   c. Phrase encoding into a numeric vector using BERT based sentence encoders solutions. Use this numeric vector to group the phrases using the clustering approaches. Here, the cosine similarity matrix to cluster the phrases is used.
   d. The output of this step is to identification of the right phrase among all similar phrases and use that right phrase instead of the similar phrases.
19. Relationship extraction between the key phrases in a text document. Once the quality right phrases from the above step, derive the relationships among them in the text documents based on the contexts occurring in the document.
20. Using the key phrases and their relationships, derive a knowledge graph as follows:
   a. Each key phrase is a node in the knowledge graph.
   b. If there exists a relationship between two phrases, then connect those phrases nodes and form edge relationship in the graph.
   c. For each word in the phrase, derive lemma and then create them as nodes for the lemma in the knowledge graph.
   d. Connect the lemma words to the phrases using their corresponding nodes as edges in the knowledge graph.
   e. Store phrases document ids and statistical details about phrases such as frequency, Term Frequency—Inverse Document Frequency (TF-IDF) etc. in the knowledge graph database.
21. Predicting top-n key vocabulary based on search string:
   a. Text cleaning steps for search string as mentioned above.
   b. Find the lemma for each word in the cleaned search string.
   c. For each lemma word, find the related key phrases from the knowledge graph.
   d. Find the intersection of key phrases thus identified.
   e. Order those phrases identified through intersection using the ranking criteria based on the phrases statistics.
   f. Select and return the top-n best key phrases as search results.
   g. The search results and shown as word cloud for the researcher to quickly identify the key vocabulary they are interested in.

The search results are also shown in a table next to the word cloud. The researcher can click on a particular key vocabulary. Return the search results from any search engine to the researcher for gaining knowledge on the topic useful for the research.

The technical effects of the present invention are:
Preprocessing of text from documents to eliminate different types of noise in the text
Text Cleaning of document such as Wrong hyphenation of words, some compound words are hyphenated,
Identifying domain specific vocabulary
Improving the quality of the key phrases (105) by addressing the above problems using the transformer models
Deriving a knowledge graph as follows:
   h. Each key phrase is a node in the knowledge graph.
   i. If there exists a relationship between two phrases, then connect those phrases nodes and form edge relationship in the graph.
   j. For each word in the phrase, derive lemma and then create them as nodes for the lemma in the knowledge graph.
   k. Connect the lemma words to the phrases using their corresponding nodes as edges in the knowledge graph.
   l. Store phrases document ids and statistical details about phrases such as frequency, Term Frequency—Inverse Document Frequency (TF-IDF) etc. in the knowledge graph database.
Predicting top-n key vocabulary based on search string. The search results and shown as word cloud for the researcher to quickly identify the key vocabulary they are interested in.
   Integration with AI Chips:

In the present invention, the hardware accelerators such as Nvidia H100 GPU and Field Programmable Gate Arrays (FPGAs) have been used. These hardware are used in the present invention in the following two ways:
1. By enhancing the acceleration capabilities of the hardware to the maximum extent to increase the efficiency in processing and reducing the training and inference costs.
2. By providing a set of instructions related to the models for retrieval of comprehensive knowledge phrases.

By using the above hardware's, the present invention has been able to speed up, improve efficiency and reduce inference costs of multiple models pipeline during training phase and in the inference phase of discovering knowledge phrases for users search queries, which is quite different from regular Large Language Models such as GPT-4 which is a single model with billions of parameters and training those models require hundreds of thousands of GPUs and millions of dollars training the model of huge set of training documents.

The present invention focuses on improving efficiency and costs which is achieved by decomposing the difficult problem into multiple models such as language detection, innovative phrase extraction, cleaning up of phrases, grouping of semantic similar knowledge phrases, building the strength of relationships between knowledge phrases dynamically and context sensitive knowledge discovery etc.

The present invention develops models in training phrase of the multiple models considering many of the below hardware factors to create optimized models for our innovation and taking full advantage of hardware capabilities.

The following are hardware related steps that has been incorporated in the present invention for training multiple models.
1. Tensor cores for efficient matrix multiplications.
2. Transformer Engine for handling sparse vectors and quantization.
3. Data partitioning and memory management to efficiently transfer between computer memory and GPUs memory and reduce wait times of GPU and utilizing memory bandwidth.
4. Utilize hardware's data parallel compute capabilities to the maximum extent possible using hardware units such as convolute cores, single data processor, Channel Data Processors for normalization functions, Data Reshape engine and Pooling Engine etc.
5. Utilize Highly Parallel Graph Computations of compute processors that include large-scale graph traversals, knowledge search, and reasoning due to availability of hundreds of thousands of processing cores.
6. Building powerful GNNs (Graph Neural Networks) for knowledge representation learning and relationship prediction.

The following are hardware related steps that has been incorporated in the present invention for Inference of Knowledge Phrases:

The inference process is enabling users to discover comprehensive list of knowledge queries, which are very important for the following reasons.
1. Semantic Understanding and Relevance Ranking: Our semantic understanding powered models grasp the intent and context of search queries, going beyond mere keyword matching. Our innovative solution using the present invention enables Knowledge engine to discover context and intent of user to provide more meaningful and comprehensive key phrase results that align with the user's intent. This ensures that the most relevant results of knowledge discovery are presented to the user at the top of the search results.
2. Real-time Search: Develop abilities for real-time search capabilities, allowing search engines to provide results as users type their queries. This enhances the user experience by providing immediate feedback and reducing perceived latency.

Inferencing utilizes the large-trained models to understand the context of search query and traverse semantic knowledge graph to provide comprehensive knowledge phrases to user. If the deployment of the present invention is on normal computational infrastructure, it will be prohibitively expensive with potentially slow responses to users. Scalability to cater to the needs of thousands of users requires data center kind of capabilities with hundreds of GPUs. To overcome the above challenges, we are utilizing Field Programmable Gate Arrays (FGPAs) to make efficient inferencing of knowledge phrases discovery for users search query. This involves mapping of multiple computational language model flows on FPGAs by utilizing its resources such as heterogenous memory hierarchy, sparse computational chains, reducing model sizes by orders of magnitude using mixed precision, taking advantage of high memory bandwidth of FPGAs, Leveraging their parallelization and vectorization of computations,

Building custom data paths to execute multiple instructions simultaneously on multiple blocks of data to gain high though put and low latency, etc.

The approach not only helps improve computational efficiency, it also significantly reduces power consumption significantly for giving comprehensive knowledge phrases results each search query.

### Cognating Application Numbers:

Indian Patent Application No. 202341051765 dated Jan. 8, 2023 Granted on 18 Mar. 2024 with Grant no 528809

We claim:

1. A system for generating key vocabulary phrases, comprising:
a. a processor, wherein the processor is configured to perform an operation that generate phrases, the operation comprising:
i. receiving a user-specified term or phrases that involves text cleaning;
ii. deriving a knowledge graph using the relationship of plurality of key phrases, thereby deriving a lemma;
iii. improving the quality of the key phrases using the transformer models;
iv. storing phrases, document ids and statistical details about phrases such as frequency, TF-IDF in a knowledge graph database;
v. ordering the phrases identified using the ranking criteria based on the phrases statistics;
vi. selecting and returning best key phrases as search results; and
vii. showing the search results as word cloud for the users to quickly identify the key vocabulary.

2. A non-transitory computer-readable storage medium storing instructions that, when executed by a processor, cause a computer system to generate phrases, by performing the steps of:
i. receiving a user-specified term or phrases that involves text cleaning;
ii. deriving a knowledge graph using the relationship of plurality of key phrases, thereby deriving a lemma;
iii. improving the quality of the key phrases using the transformer models;
iv. storing phrases, document ids and statistical details about phrases such as frequency, TF-IDF in a knowledge graph database;
v. ordering the phrases identified using the ranking criteria based on the phrases statistics;
vi. selecting and returning best key phrases as search results; and
vii. showing the search results as word cloud for the users to quickly identify the key vocabulary.

3. A computer-implemented method (100) for generating key vocabulary phrases, the method comprising the steps of:
receiving (101) a user-specified term or phrases by means of typing text or voice input and involves in text cleaning (101A), wherein the means of typing text or voice input denotes the mode of input through input devices such as keyboard, touchscreen, microphone and other such devices to the method (100) for generating vocabulary phases;
identifying (102) domain specific vocabulary;
extracting (103) relationship between plurality of key phrases in a text document;
deriving (104, 104A-104D) a knowledge graph using the relationship of plurality of key phrases, wherein each key phrase is a node in the knowledge graph and the relationship between two phrases establish a connection to form edge relationship in the knowledge graph, thereby deriving a lemma;
improving (105) the quality of the key phrases using the transformer models;
storing (106) phrases, document ids and statistical details about phrases such as frequency, TF-IDF in a knowledge graph database;
ordering (107) the phrases identified using the ranking criteria based on the phrases statistics;
selecting (108) and returning best key phrases as search results;
characterized by that,
the text cleaning (101A) step comprising:
extracting user specified text from the documents using approaches such as image to text, HTML parsing, PDF parsing and other such approaches;
preprocessing the extracted text from documents to eliminate different types of noises in the text, wherein the preprocessing step extracted text involving noise removal comprises of noises such as mathematical equations, figures, pictures, flowcharts, tables, non-english text, HTML links and other such noises;
extracting the text along with relevant meta data details using libraries, wherein the step of extracting text involves in removal of wrong hyphenation, incorrect fusing of two or more words, and spelling mistakes;
and showing (109) the search results as word cloud for the users to quickly identify the key vocabulary.

4. The method as claimed in claim 3, wherein the improving (105) step of the quality of the key phrases uses BERT variants.
